(19) United States
(12) Patent Application Publication
(10) Pub. No.: US 2006/0054102 A1
(43) Pub. Date: Mar. 16, 2006

(54) Animal shelter

(76) Inventor: Tracey J. Hailey, Crestwood, KY (US)

Correspondence Address: CARRITHERS LAW OFFICE, PLLC;One Paragon Centre, Suite 140, 6060 Dutchman's Lane, Louisville, KY, 40205, US

(21) Appl. No.: 10/941,263

(22) Filed: Sep. 15, 2004

(51) Int. Cl. A01K 1/03

(52) U.S. Cl. 119/482

(57) ABSTRACT

An animal shelter that provides indoor and outdoor accommodation for an animal that includes an insulated, moisture impervious floor panel with a controllable heat producing element therein. Insulated wall panels are secured to the floor panel and extending upwardly therefrom around the outer periphery thereof. An insulated roof panel is supported by the walls and has an upper flat surface on which the animal can lie outside of the shelter. The roof panel can be tilted upwardly providing access to the interior of the shelter. The front panel can be removed for ventilation. An opening in a side wall panel permits the animal to enter and exit the shelter at will. First and second compartments hold respectively a supply of food and water and each have an open top tray portion, located within the shelter, which is accessible by an animal located in the shelter.

### FIELD OF INVENTION

This invention relates to a self contained animal shelter, i.e. a dog house, that has a heated floor, that has provisions for holding a supply of food and water accessible to an animal in the shelter and that has an elevated flat surface on the outside of the shelter and on which the animal can lie. Preferably the food is automatically dispensed in proportions appropriate for the animal that is housed in the shelter.

### BACKGROUND OF INVENTION

Pet shelters that are controllably heated are known and by way of example to the following references.

U.S. Pat. No. 5,003,923 granted Apr. 2, 1991 to S. D. Morgan and entitled “Heated Pet House” discloses a shelter particularly for housing pets outdoors. The shelter includes a floor, side walls extending upwardly around the outer periphery of the floor and a roof that overlies the floor and side walls. Animal access to the interior is through a flap covered opening in one of the side walls. The roof is pitched and includes a hingedly connected portion that provides easy and quick access to the interior of the shelter. A thermostatically controlled electric space heater is located within the enclosure for heating the same. One embodiment includes a pressure sensitive switch allowing operation of the heating element only when an animal is present in the shelter.

One of the drawbacks of the foregoing patented structure is the reduction of the interior space of the enclosure corresponding to the space occupied by the electric heater. Another drawing back is that heating space is inefficient. Furthermore heating the space around the animal does not necessarily mean the animal is comfortable. The floor on which the animal is lying can be damp and/or cold in which case virtually no amount of space heating will make the animal comfortable. Also a damp and/or cold floor is detrimental to the animals health and general well being. The reference neither teaches nor suggest insulating the enclosure or providing means for holding a supply of liquid refreshment or food for the occupant of the shelter.

An animal shelter provided with a food dispenser is disclosed in U.S. Pat. No. 4,334,501 granted Jun. 15, 1982 to D. G. McDaniel et al. The shelter has a flat roof with a hingedly connected portion permitting access necessary for refilling the water and food compartments. A bowl on the roof provides the animal shelter “with the appearance of having a chimney”. U.S. Pat. No. 5,148,768 granted Sep. 22, 1982 to M. Hinton discloses a shelter with multiple compartments therein and is intended primarily for cats. A heating pad on which an animal can lie is disclosed in U.S. Pat. No. 6,294,768 granted Sep. 25, 2001 to E. Liebich

### SUMMARY OF INVENTION

An object of the present invention is to provide a comfortable, self contained, efficiently heated, animal enclosure suitable not only for pets but also watch dogs. Watch dogs in many instances live outdoors year round and provide protection for selected fenced in properties that often cannot be appropriately or completely protected by electronic surveillance equipment. It is important to provide such animals with comfortable accommodation not only during inclement weather but also good weather. It is also important to provide the animal with a supply of food and water that lasts for long periods of time.

In keeping with the foregoing there is provided in accordance with the present invention an animal shelter that provides indoor and outdoor accommodation for the animal, the shelter comprising an insulated floor panel that is moisture impervious and includes a controllable heat producing means extending over a preselected area thereof. Insulated wall panels secured to the floor panel and extend upwardly therefrom around the outer periphery thereof. An insulated roof panel is supported by the walls and means pivotally connecting the roof panel to the shelter are included whereby the roof panel can be tilted upwardly providing access to the interior of the shelter. The shelter has a flat upper elevated surface on the outside thereof on which the animal can lie. An opening in one of the side wall panels permits the animal to enter and exit the shelter at will. First and second compartments for holding respectively a supply of food and water, are incorporated therewith, wherein each compartment has at the lower end thereof an open top tray portion projecting into the shelter for easy assess by the animal.

These and other objects of the present invention will be more fully understood from the following description of the invention.

### BRIEF DESCRIPTION OF THE DRAWINGS

A better understanding of the present invention will be had upon reference to the following description in conjunction with the accompanying drawings in which like numerals refer to like parts throughout the several views and wherein:

FIG. 1 is a front elevational view of an animal shelter provided in accordance with the present invention;

FIG. 2 is a vertical left hand side view of the shelter illustrated in FIG. 1;

FIG. 3 is a top plan of the shelter illustrated in FIGS. 1 and 2 with the roof removed for clarity;

FIG. 4 is a sectional view taken essentially along line 4-4 of FIG. 1;

FIG. 5 is an enlarged detail view of the encircled portion in FIG. 1 designate A; and

FIG. 6 is front elevational view of further embodiment of the animal shelter provided in accordance with the present invention.

### DETAILED DESCRIPTION OF PREFERRED EMBODIMENT

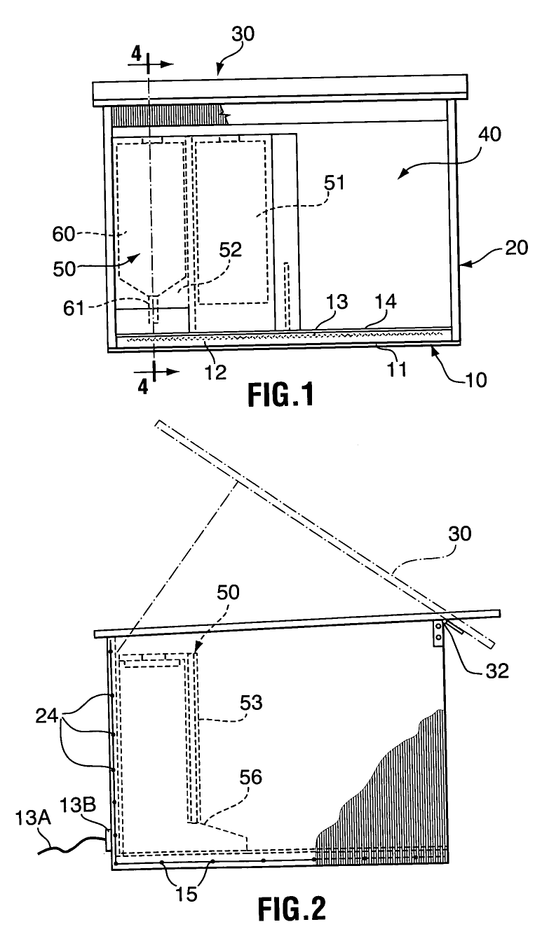

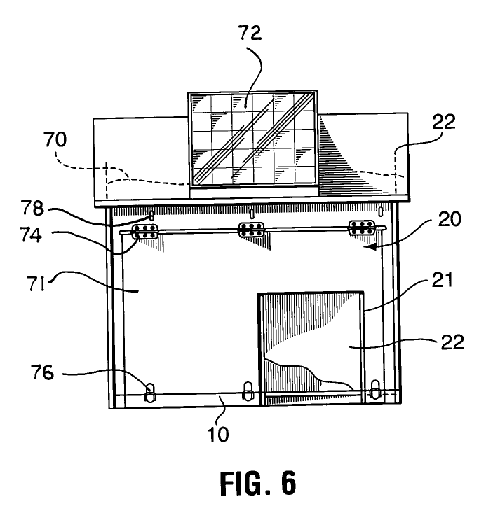

Illustrated in FIGS. 1-6, is an animal shelter that includes a floor 10, vertically disposed side walls 20 extending upwardly around the outer periphery of the floor and a roof 30 that rests on the side walls. As best shown in FIG. 6, one of the side walls comprises a front panel provided with an opening 21 that is covered by a flap 22 allowing an animal to freely enter and exit the enclosed area 40 defined by the foregoing floor, walls and roof. The enclosed area provides indoor accommodation to protect an animal during times of inclement weather.

All of the components of the enclosure can be composed of injection molded plastic, fiberboard, wood, metal, fiberglass, corrugated material, composite material or combinations thereof.

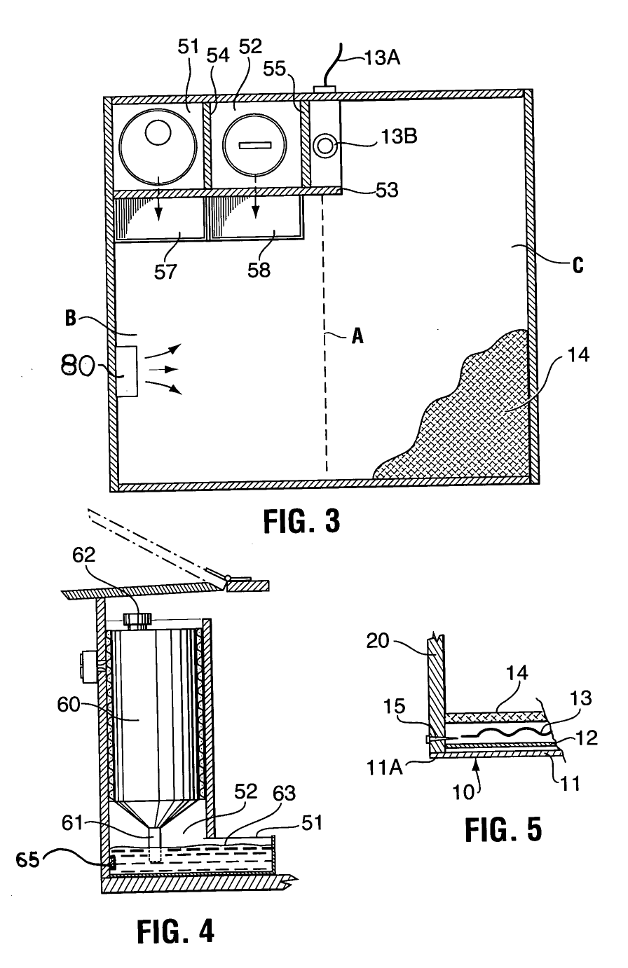

The floor is multilayered and includes a bottom vapor barrier layer 11, an insulation layer 12, a heating layer 13 and a removable carpet, mat, or the like soft floor covering top layer 14 for the animal to lie on. The floor by way of example may cover an area 4 ft×4 ft and may consist of a single panel or two or more panels disposed side-by-side. The heating layer extends over a selected area of the floor and that selected entire area can be the entire floor or only a selected portion thereof. In the latter instance the animal has a choice of lying on the heated or unheated portion of the floor. The floor may consist of two (2×4 foot) panels disposed side-by-side and only one of which has a heat producing layer and the other one of which does not. Should both panels have a heat producing layer one or the other or both maybe connected for operation. In FIG. 3, a broken line A illustrates a division between two side-by-side floor panels designated respectively B and C.

The heat producing element is preferably an electrical resistance heating element that can be connected to a suitable power source by a cord 13A and is thermostatically controlled by a thermostat 13B.

The side walls 20 are insulated and rest on a portion 11A of the vapor barrier layer 11 that projects outwardly beyond the remaining layers of the floor. The walls are connected to the floor by a plurality of spaced apart screws 15 or the like. The adjacently disposed wall panels are connected to one another at the corners of the shelter by a plurality of screws 24. The shelter can thus be shipped in a knock down state and readily assembled at the site of use by driving in a few screws.

The roof rests on the upper edge of the side walls and is hingedly connected as indicated at 32 to one of the side walls 20 permitting tilting the roof as indicated in broken line in FIG. 2. This provides access to the interior of the shelter in which there is located a food/water storage and dispensing unit 50.

The roof 30 has a flat upper outdoor elevated surface 31 on which the animal can lie and thereby protected from a wet and/or cold ground.

The food/water unit 50 is located within the enclosure and includes side-by side compartments 51, 52 respectively for water and food for the occupant of the shelter. The compartments are provided by a first vertical panel 53 disposed parallel to and spaced from one of the side walls 20, and in end abutting relation with a side wall adjacent and perpendicular to said one wall, and a spaced apart pair of dividers 54, 55. The panel 53 has a lower edge 56 that is spaced upwardly a selected distance from the upper surface of the floor 10.

The compartments 51, 52 have means in a lower portion thereof to controllably dispense the contents into respective tray like portions 57, 58 that project into the interior of the shelter beyond the panel 53.

The side-by-side compartments can be provided by a molded plastics unit that is mounted or suspended (detachably if so desired) in any convenient manner on one of side walls or two juxtaposed angularly related side walls. The molded plastics construction permits pouring the food and water directly into the respective compartments and when the unit is detachably mounted it can readily be removed for cleaning or replacement should that be necessary. If desired the water maybe contained in a separate container 60 such as a bottle that is removably mounted in the compartment for the water. The bottle has at the top a filler neck 62 with a removable cap and at the bottom an open ended neck 61 that terminates a selected depth below the surface 63 of water in the tray associated therewith. As shown in FIG. 4, the container 60 can be insulated and the contents maintained at a controlled temperature by a means of heating such as an electrical wrap or the like. In addition, a submersible coil or other means of heating the water in the bowl can be utilized instead of or in combination with container water heater. The container also includes a drain plug 62 and optional valve. A watering device having an automatic level control can be utilized with the container. Such devices are commercially available. An additional water heating element can also be placed in the water bowl 65 in fluid communication with the bottle.

As shown in FIG. 4, the roof portion above the water and food compartments is hinged in one preferred embodiment providing access thereto. It is contemplated that a portion of the floor can be nested within the enclosure and be extended outwardly from the enclosure on a track or rail assembly providing for a heatable porch for the animal.

FIG. 6 also shows a portion defining a panel 71 of the removable front side wall 20 being removably fastened to the enclosure roof with hinges 74 on the top and means for fastening such as buckle fasteners 76 on the bottom so that the front panel 71 can be raised and pivoted to provide a canopy to protect an animal lying outside the enclosure from the sun. The canopy formed by the raised panel 71 can be held in position by means for supporting such as struts or cables extending from the distal corners of the side wall to the bolts 78 or other means of holding anchoring same to the front of the enclosure.

The food can, if desired, be controllably supplied to the tray associated therewith in timed, measured, quantities appropriate for the animal that is the occupant of the shelter and dispensed by commercially available dispensers serving a particular quantity or weight upon being activated by the handler or animal.

In FIG. 6, it will be noted there is a preferably weather resistant sleeping pad 70 on the upper outer flat surface of the roof. The roof has an upstanding ledge 25 extending around at least a major portion of the periphery of the roof. The pad 70, if desired, have a heat producing element therein. This pad for example maybe as disclosed in the aforementioned U.S. Pat. No. 6,294,768 the disclosure of which is incorporated herein by reference thereto. A pressure sensitive switch can be located in or under this pad so that heat is provided only when the animal is on the pad.

Also, a fan 80 such as a circulation fan or ventilation fan can be disposed in a selected location within the enclosure and optionally controlled by a thermostat.

The power for the enclosure is provided with direct current or batteries. As shown in FIG. 6, a solar panel 72 can optionally be utilized to provide electrical energy which can be used for powering the heating floor panels, heating the water, running a fan, operating food or water dispensers, or recharging batteries.

The foregoing detailed description is given primarily for clearness of understanding and no unnecessary limitations are to be understood therefrom, for modifications will become obvious to those skilled in the art based upon more recent disclosures and may be made without departing from the spirit of the invention and scope of the appended claims.

I claim:

1. An animal shelter that provides indoor and outdoor accommodation for the animal, said shelter comprising:
an insulated floor panel that is moisture impervious and includes a controllable heat producing means extending over a selected area of the floor;
insulated wall panels secured to said floor panel and extending upwardly therefrom around the outer periphery thereof,
an insulated roof panel supported by said walls and having a flat upper surface on which the animal can lie;
means pivotally connecting said roof panel to said shelter whereby said roof panel can be tilted upwardly providing access to the interior of the shelter,
an opening in one of said side wall panels permitting the animal to enter and exit the shelter at will; and
first and second compartments for holding respectively a supply of food and water and each having an open top tray portion, located within the shelter, which is accessible by an animal located in the shelter.

2. The animal shelter as defined in claim 1 wherein said floor panel has a lower impervious layer, wherein said impervious layer projects outwardly beyond the remaining portion of the panel around the entire periphery thereof and wherein said walls rest on said outwardly projecting portion.

3. The animal shelter as defined in claim 1 wherein said heated producing means extends over approximately one half of the floor area.

4. The animal shelter as defined in claim 1 wherein said heat producing means extends over substantially the entire floor area.

5. The animal shelter as defined in claim 1 including a weather resistant pad on said flat upper surface of the roof.

6. The animal shelter as defined in claim 6 wherein said pad includes heat producing means therein.

7. The animal shelter as defined in claim 1 including means detachably connecting said wall panels to one another and to said floor panel.

8. The animal shelter as defined in claim 1 including a removable front side wall panel.

9. An animal shelter that provides indoor and outdoor accommodation for the animal, said shelter comprising:
a multilayer insulated floor panel that includes a bottom moisture impervious layer, an insulating layer on said bottom layer a controllable electrical resistance heating element extending over a selected area of the panel and a top cushion layer on which the animal lies, said moisture impervious layer extending outwardly laterally beyond the remaining layers;
insulated wall panels resting at the lower edge thereof on said laterally projecting portion of the bottom layer and projecting upwardly therefrom;
means detachably securing said wall panels to one another and to said floor panel;
an insulated roof panel supported by said wall panels and having a flat upper surface on which the animal can lie;
means pivotally connecting said roof panel to said shelter whereby said roof panel can be tilted upwardly providing access to the interior of the shelter,
a weather resistant pad on said flat upper surface of the roof;
an opening in one of said side wall panels permitting the animal to enter and exit the shelter at will; and
first and second compartments for holding respectively a supply of food and water and each having an open top tray portion, located within the shelter, which is accessible by an animal located in the shelter.

10. The animal shelter of claim 9, including a nestable extendible porch floor.
